(19) United States
(12) Patent Application Publication
(10) Pub. No.: US 2017/0032886 A1
(43) Pub. Date: Feb. 2, 2017

(54) COIL ELECTRONIC COMPONENT AND METHOD OF MANUFACTURING THE SAME

(71) Applicant: SAMSUNG ELECTRO-MECHANICS CO., LTD., Suwon-si (KR)

(72) Inventors: Jae Hun KIM, Suwon-si (KR); Boum Seock KIM, Suwon-si (KR); Byeong Cheol MOON, Suwon-si (KR)

(21) Appl. No.: 15/075,987

(22) Filed: Mar. 21, 2016

(30) Foreign Application Priority Data
Jul. 30, 2015 (KR) 10-2015-0108245

(51) Int. Cl. H01F 27/29; H01F 41/10; H01F 27/28

(52) U.S. Cl. CPC H01F 27/292; H01F 27/2804; H01F 41/10

(57) ABSTRACT

A coil electronic component includes a body region including a first surface and a second surface opposing each other and a body region including a magnetic material, a wound coil having at least a portion embedded in the body region and disposed perpendicularly with respect to the first surface, and first and second leads connected to the wound coil and exposed through the second surface to be extended to the first surface.

### CROSS-REFERENCE TO RELATED APPLICATION

This application claims the benefit of priority to Korean Patent Application No. 10-2015-0108245, filed on Jul. 30, 2015 with the Korean Intellectual Property Office, the entirety of which is incorporated herein by reference.

### TECHNICAL FIELD

The present disclosure relates to a coil electronic component and a method of manufacturing the same.

### BACKGROUND

In recent years, manufactured electronic devices have increasingly come to use power inductors to reduce current loss and increase efficiency. In addition, as electronic devices have become slimmer, the demand for thinner, miniaturized internal components for the electronic devices has also increased.

Power inductors may be largely classified into a multilayer type, a thin film type, and a wire-wound type according to the structure and mechanism of the power inductor. A multilayer type power inductor may be limited with regard to implementing certain electronic characteristics, but has excellent characteristics with respect to miniaturization and mass production. A thin film type power inductor may be used in fields required for a micro capacity control, but has a limit with regard to implementing large capacity. Since a wire-wound power inductor may have low resistance values for its lines and therefore may have a high Q value and a small parasitic capacitance value occurring between the lines, it may have excellent characteristics such as a high self resonance frequency, high capacity, and high withstand voltage characteristics, but it may be difficult to miniaturize and may be difficult to mass produce, making it more expensive.

### SUMMARY

An aspect of the present disclosure provides a coil electronic component capable of being miniaturized and stably mounted.

Another aspect of the present disclosure provides a method of manufacturing a coil electronic component having an easy process and excellent position precision of a coil.

According to an aspect of the present disclosure, a new structure of a coil electronic component is provided which may be easily miniaturized and has excellent reliability. In detail, the present disclosure provides a new structure of a coil electronic component capable of being easily miniaturized and having excellent reliability by disposing, perpendicularly to a mounting surface, a wound coil embedded into a body region and drawing first and second leads connected to the wound coil to a surface opposing the mounting surface.

### BRIEF DESCRIPTION OF THE DRAWINGS

The above and other aspects, features, and advantages of the present disclosure will be more clearly understood from the following detailed description taken in conjunction with the accompanying drawings, in which:

FIG. 1 is a perspective view of a coil electronic component according to an exemplary embodiment;

FIG. 2 is a perspective view schematically illustrating a wound coil of the coil electronic component according to the exemplary embodiment;

FIG. 3 is a perspective view schematically illustrating a wound coil of a coil electronic component according to another exemplary embodiment;

FIG. 4 is a perspective view schematically illustrating a wound coil of a coil electronic component according to another exemplary embodiment;

FIG. 5 is a perspective view schematically illustrating a wound coil of a coil electronic component according to another exemplary embodiment; and

FIGS. 6A through 6E are diagrams sequentially illustrating a method of manufacturing a coil electronic component according to an exemplary embodiment.

### DETAILED DESCRIPTION

Hereinafter, embodiments of the present inventive concept will be described as follows with reference to the attached drawings.

The present inventive concept may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

Throughout the specification, it will be understood that when an element, such as a layer, region or wafer (substrate), is referred to as being “on,” “connected to,” or “coupled to” another element, it can be directly “on,” “connected to,” or “coupled to” the other element or other elements intervening therebetween may be present. In contrast, when an element is referred to as being “directly on,” “directly connected to,” or “directly coupled to” another element, there may be no elements or layers intervening therebetween. Like numerals refer to like elements throughout. As used herein, the term “and/or” includes any and all combinations of one or more of the associated listed items.

It will be apparent that though the terms first, second, third, etc. may be used herein to describe various members, components, regions, layers and/or sections, these members, components, regions, layers and/or sections should not be limited by these terms. These terms are only used to distinguish one member, component, region, layer or section from another region, layer or section. Thus, a first member, component, region, layer or section discussed below could be termed a second member, component, region, layer or section without departing from the teachings of the exemplary embodiments.

Spatially relative terms, such as “above,” “upper,” “below,” and “lower” and the like, may be used herein for ease of description to describe one element's relationship to another element(s) as shown in the figures. It will be understood that the spatially relative terms are intended to encompass different orientations of the device in use or operation in addition to the orientation depicted in the figures. For example, if the device in the figures is turned over, elements described as “above,” or “upper” relative to other elements would then be oriented “below,” or “lower” relative to the other elements or features. Thus, the term “above” can encompass both the above and below orientations depending on a particular direction of the figures. The device may be otherwise oriented (rotated 90 degrees or at other orientations) and the spatially relative descriptors used herein may be interpreted accordingly.

The terminology used herein is for describing particular embodiments only and is not intended to be limiting of the present inventive concept. As used herein, the singular forms “a,” “an,” and “the” are intended to include the plural forms as well, unless the context clearly indicates otherwise. It will be further understood that the terms “comprises,” and/or “comprising” when used in this specification, specify the presence of stated features, integers, steps, operations, members, elements, and/or groups thereof, but do not preclude the presence or addition of one or more other features, integers, steps, operations, members, elements, and/or groups thereof.

Hereinafter, embodiments of the present inventive concept will be described with reference to schematic views illustrating embodiments of the present inventive concept. In the drawings, for example, due to manufacturing techniques and/or tolerances, modifications of the shape shown may be estimated. Thus, embodiments of the present inventive concept should not be construed as being limited to the particular shapes of regions shown herein, for example, to include a change in shape results in manufacturing. The following embodiments may also be constituted by one or a combination thereof.

The contents of the present inventive concept described below may have a variety of configurations and propose only a required configuration herein, but are not limited thereto.

Coil Electronic Component

Hereinafter, a coil electronic component according to an exemplary embodiment is described, and more particularly, a wire-wound inductor will be described as an example. However, the coil electronic component according to the exemplary embodiment is not necessarily limited thereto.

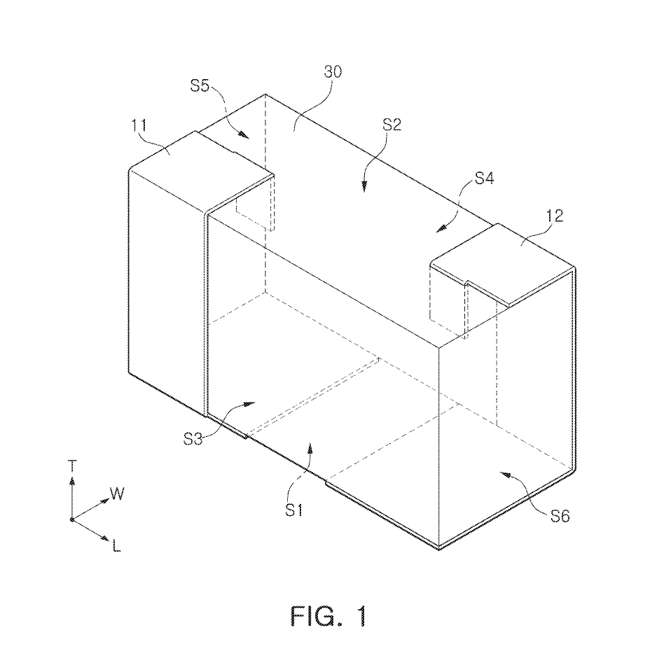

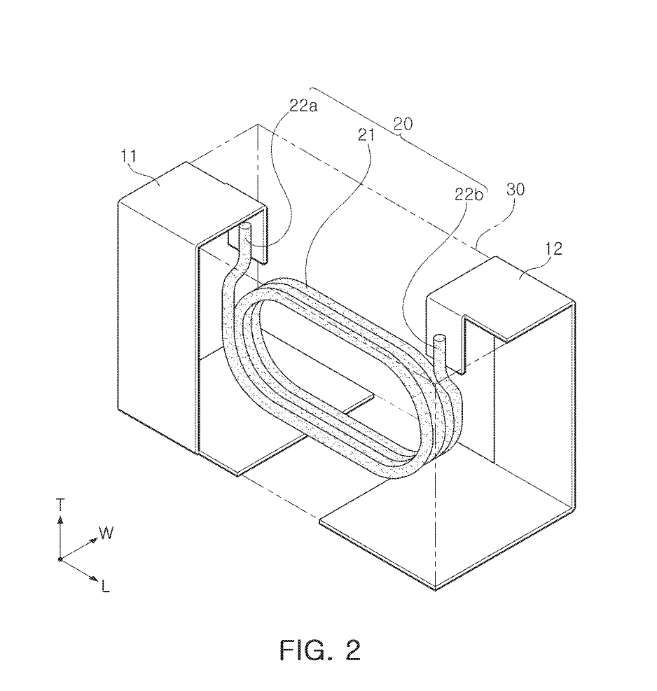

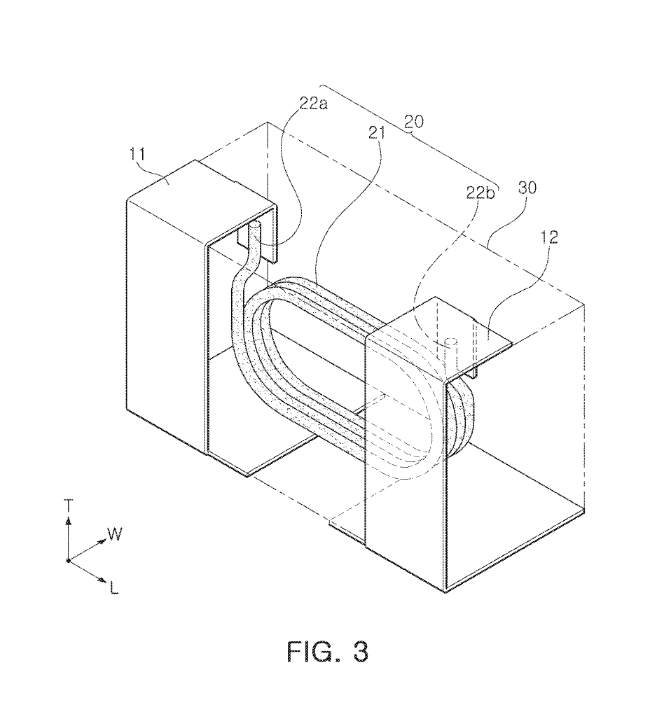

FIG. 1 is a perspective view of a coil electronic component according to an exemplary embodiment, FIG. 2 is a perspective view schematically illustrating a wound coil of the coil electronic component according to the exemplary embodiment, and FIG. 3 is a perspective view schematically illustrating a wound coil of a coil electronic component according to another exemplary embodiment.

Based on FIG. 1, in the following description, a ‘length’ direction may be defined as an ‘L’ direction, a ‘width’ direction may be defined as a ‘W’ direction, and a ‘thickness’ direction may be defined as a ‘T’ direction in FIG. 1.

Referring to FIGS. 1 through 3, a coil electronic component according to an exemplary embodiment may include a body region 30, a wound coil 20, a first lead 11, and a second lead 12.

The body region 30 may form an exterior of the coil electronic component and may be a space in which, upon applying a current to the wound coil 20 through first and second leads 11 and 12, a magnetic path through which a magnetic flux induced from the wound coil 20 passes is formed.

The body region 30 may include a magnetic material and may be formed of magnetic powder and thermosetting resins of epoxy, polyimide, or the like, interposed between the magnetic powder.

As a detailed example, the magnetic powder may be ferrite powder or magnetic metal powder exhibiting magnetic properties. Further, the ferrite powder may include one or more selected from the group consisting of Mn—Zn based ferrite powder, Ni—Zn based ferrite powder, Ni—Zn—Cu based ferrite powder, Mn—Mg based ferrite powder, Ba based ferrite powder, and Li based ferrite powder, and the magnetic metal powder may include one or more selected from the group consisting of iron (Fe), silicon (Si), chromium (Cr), aluminum (Al), and nickel (Ni).

A shape of the body region 30 is not particularly limited, but as illustrated, the body region 30 may have a hexahedral shape. The body region 30 may not have a completely hexahedral shape due to burning shrinkage of the magnetic powder or the like upon burning, but may substantially have the hexahedral shape.

The body region 30 may have a first surface S1 and a second surface S2 opposing each other, a third surface S3 and a fourth surface S4 opposing each other in a width direction to connect between the first and second surfaces, and a fifth surface S5 and a sixth surface S6 opposing each other in a length direction. In this case, the first surface S1 may be provided as a mounting surface.

At least some of the wound coil 20 may be embedded into the body region 30 and disposed perpendicularly with respect to the first surface S1.

As such, the coil electronic component according to the exemplary embodiment may greatly reduce areas of the first and second surfaces of the body region 30 as the wound coil 20 is disposed perpendicularly with respect to the first surface S1 of the body region 30, to thereby remarkably reduce the mounting area.

The wound coil 20 may be formed as a metallic wire of copper (Cu), silver (Ag), or the like, and may include a spiral portion 21 and a pair of lead parts 22a and 22b each drawn from the spiral portion 21. In this case, the pair of lead parts may be drawn in the same direction.

The wound coil 20 may not be limited to a single wire, and may be formed of a twisted wire or two or more wires. Further, the wound coil 20 is not limited to one having a circular cross section shape, and therefore may also have various known cross section shapes such as a quadrangle.

The first and second leads 11 and 12 may be each connected to the pair of lead parts 22a and 22b of the wound coil 20 and exposed through the second surface S2 of the body region 30 to be extended to the first surface S1.

As such, since the first and second leads 11 and 12 are exposed through the second surface to be extended to the first surface, and therefore when the substrate is mounted by a solder the solder may contact an end surface of the body region 30, the coil electronic component according to the exemplary embodiment may be stably mounted and remarkably reduce damage occurring due to the deformation of the substrate, thereby having excellent reliability.

Parts of the first and second leads 11 and 12 exposed externally from the body region 30 may be spaced apart from the body region 30 at a predetermined interval. That is, the parts of the first and second leads 11 and 12 exposed externally from the body region 30 may not contact the body region 30. In this case, reliability may be further improved. Alternatively, the parts of the first and second leads 11 and 12 exposed externally from the body region 30 may be disposed directly on the body region 30 without any interval.

The wound coil 20 and the first and second leads 11 and 12 may be connected to each other through welding.

Referring to FIGS. 1 and 2, the first and second leads 11 and 12 of the coil electronic component according to the exemplary embodiment may be bent in different directions and thus respectively extend on the third and fourth surfaces in the width direction to be extended to the first surface.

Referring to FIG. 3, the first and second leads 11 and 12 of the coil electronic component according to another exemplary embodiment may be bent in the same direction and thus extend on the third or fourth surfaces in the width direction to be extended to the first surface.

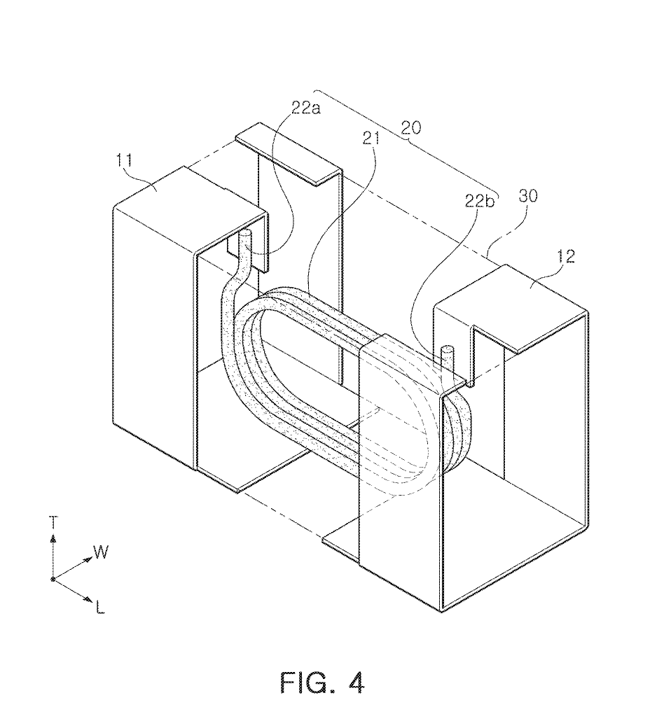

FIG. 4 is a perspective view schematically illustrating a wound coil of a coil electronic component according to another exemplary embodiment in the present disclosure.

Referring to FIG. 4, the first and second leads 11 and 12 of a coil electronic component according to another exemplary embodiment may each be extended to the surface opposite the surface each extends on in the width direction. In this case, the coil electronic component may be more stably mounted and have further improved reliability.

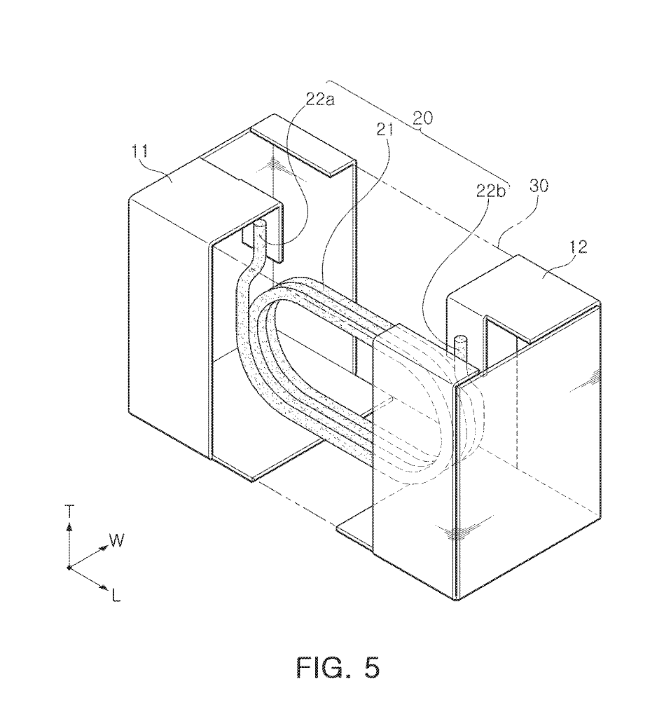

FIG. 5 is a perspective view schematically illustrating a wound coil of a coil electronic component according to another exemplary embodiment.

Referring to FIG. 5, the first and second leads 11 and 12 of a coil electronic component according to another exemplary embodiment may each be extended to a fifth surface and a sixth surface in a width direction. In this case, the coil electronic component may also be more stably mounted and have further improved reliability as well.

Method of Manufacturing Coil Electronic Component

Hereinafter, an example of a method of manufacturing a coil electronic component having the foregoing structure will be described.

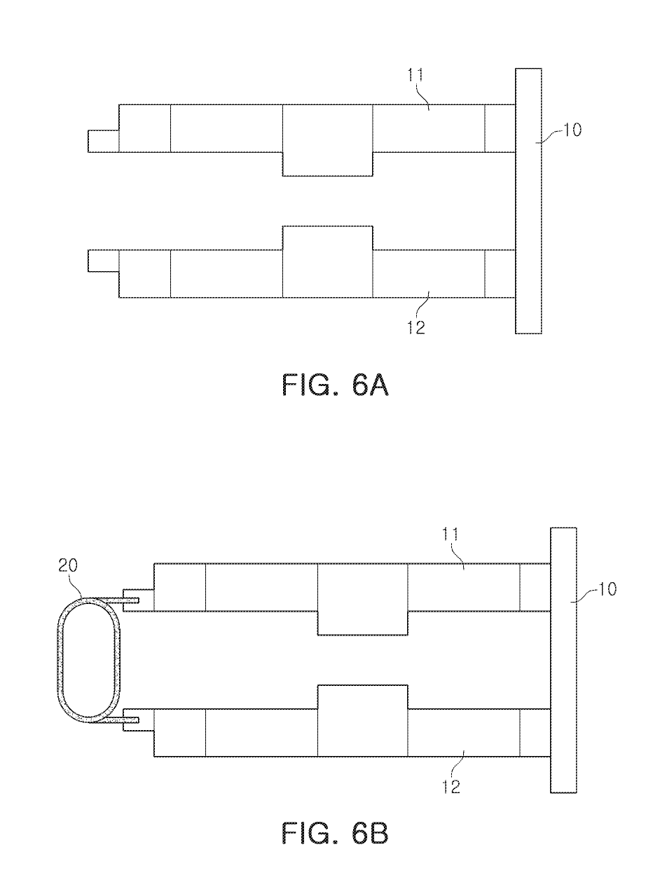

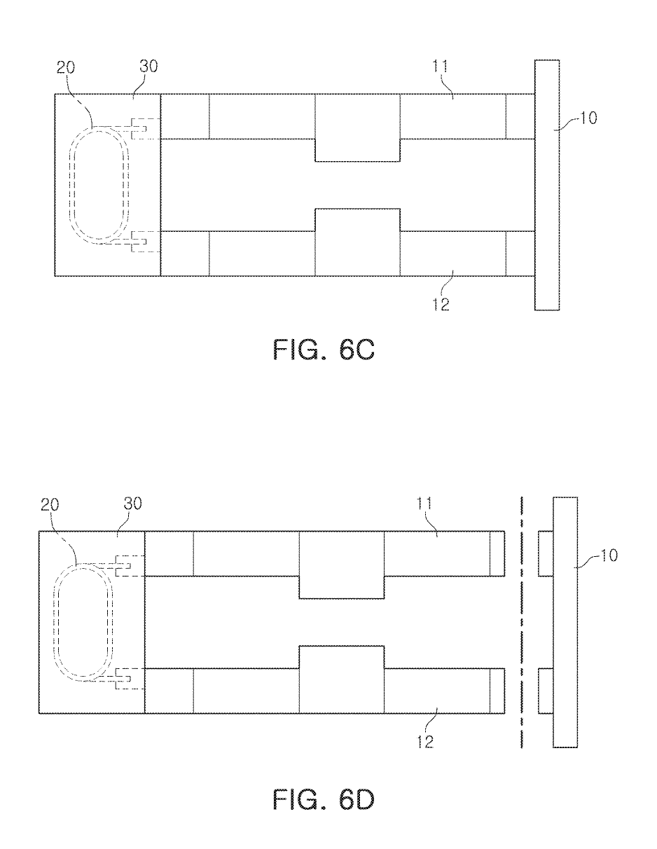

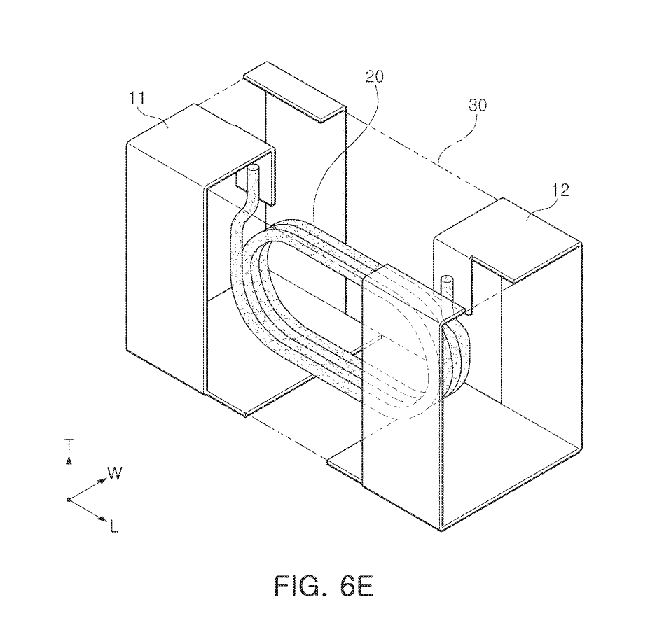

FIGS. 6A through 6E are diagrams sequentially illustrating a method of manufacturing a coil electronic component according to an exemplary embodiment.

Referring first to FIG. 6A, a lead frame 10 including the first and second leads 11 and 12 extended in the same direction is prepared.

The coil electronic component having the foregoing structure is not necessarily manufactured using the lead frame 10, but when the coil electronic component is manufactured using the lead frame 10, the wound coil may be more precisely positioned. Further, a shape and a size of an electrode may be easily controlled by controlling a shape and a length of the first and second leads 11 and 12 extended to the lead frame 10.

Next, referring to FIG. 6B, ends of the first and second leads 11 and 12 extended from the lead frame 10 are seated with the wound coil 20 and then welded. Upon the seating, the first and second leads 11 and 12 may be positioned in a vertical direction with respect to an axis of the wound coil 20.

According to the exemplary embodiment, a method of welding the wound coil to the first and second leads is not particularly limited. For example, the wound coil may be welded to the first and second leads by resistance welding, but the welding is not limited thereto.

Next, referring to FIG. 6C, the body region 30 may be formed to embed the wound coil 20 and portions of the first and second leads 11 and 12.

The method of forming a body region 30 is not particularly limited. For example, the body region may be formed by positioning magnetic sheets at upper and lower parts of the wound coil 20 and then compressing and hardening the magnetic sheets, or the body region may be formed by enclosing the wound coil 20 and portions of the first and second leads 11 and 12 with the magnetic powder and then pressing and hardening the magnetic powder by a mold.

Next, referring to FIGS. 6D and 6E, the manufacturing of the coil electronic component may be completed by cutting the first and second leads 11 and 12 from the lead frame 10 and then bending each of the portions of the first and second leads 11 and 12 externally exposed from the body region 30.

A description of features overlapping those of the electronic component according to the exemplary embodiment described above except for the above-mentioned description will herein be omitted.

As set forth above, according to exemplary embodiments, the coil electronic component may have a miniaturized mounting area.

Further, according to the exemplary embodiments, the coil electronic component may be stably mounted and have excellent reliability.

However, the useful advantages and effects of the present disclosure are not limited to the foregoing contents, but may be more easily understood from the description of the detailed exemplary embodiments.

While exemplary embodiments have been shown and described above, it will be apparent to those skilled in the art that modifications and variations could be made without departing from the spirit and scope of the present disclosure as defined by the appended claims.

What is claimed is:

1. A coil electronic component, comprising:
a body region including a first surface and a second surface opposing each other and including a magnetic material;
a wound coil having at least a portion embedded in the body region and disposed perpendicularly with respect to the first surface; and
first and second leads connected to the wound coil and exposed through the second surface to be extended to the first surface.

2. The coil electronic component of claim 1, wherein the first and second leads drawn externally are spaced apart from the body region at a predetermined interval.

3. The coil electronic component of claim 1, wherein the body region includes a third surface and a fourth surface in a width direction connecting between the first surface and the second surface, and
areas of each of the third and fourth surfaces are larger than those of the first and second surfaces.

4. The coil electronic component of claim 3, wherein the first and second leads are bent in different directions, such that the first lead extends on the third surface to be extended to the first surface and the second lead extends on the fourth surface to be extended to the first surface.

5. The coil electronic component of claim 3, wherein the first and second leads are bent in the same direction and extend on the third or fourth surface to be extended to the first surface.

6. The coil electronic component of claim 4, wherein the first and second leads are each extended to extend on both opposing surfaces in the width direction.

7. The coil electronic component of claim 4, wherein the first and second leads are extended to the fifth and sixth surfaces in the length direction, respectively.

8. The coil electronic component of claim 1, wherein the wound coil and the first and second leads are connected to each other through welding.

9. A method of manufacturing a coil electronic component, comprising steps of:
preparing a lead frame having first and second leads extended in the same direction;
seating a wound coil at ends of the first and second leads and then welding the wound coil;
forming a body region enclosing the wound coil and at least some of the first and second leads;
cutting the first and second leads from the lead frame; and
bending portions of each of the first and second leads externally exposed from the body region.

10. The method of claim 9, wherein the body region includes a first surface and a second surface opposing each other, and a third surface and a fourth surface in a width direction connecting between the first surface and the second surface, and includes a magnetic material, and
the bent first and second leads are exposed through the second surface and extend to the first surface.

11. The method of claim 10, wherein areas of each of the third and fourth surfaces are larger than those of the first and second surfaces.

12. The method of claim 9, wherein first and second leads externally drawn are spaced apart from the body region at a predetermined interval.

13. The method of claim 10, wherein the first and second leads are bent in different directions, such that the first lead extends on the third surface to be extended to the first surface and the second lead extends on the fourth surface to be extended to the first surface.

14. The method of claim 10, wherein the first and second leads are bent in the same direction and extend on the third or fourth surface to be extended to the first surface.

15. The method of claim 13, wherein the first and second leads are each extended to both opposing surfaces in the width direction.

16. The method of claim 13, wherein the first and second leads are extended to the fifth and sixth surfaces in the length direction, respectively.
